(19) United States
(12) Patent Application Publication
(10) Pub. No.: US 2020/0275801 A1
(43) Pub. Date: Sep. 3, 2020

(54) Device for Increasing Indoor Grilling Efficiency

(71) Applicant: Sergei Baranoff, West Sacramento, CA (US)

(72) Inventor: Sergei Baranoff, West Sacramento, CA (US)

(21) Appl. No.: 16/807,121

(22) Filed: Mar. 2, 2020

Related U.S. Application Data
(60) Provisional application No. 62/812,310, filed on Mar. 1, 2019.

(51) Int. Cl. A47J 37/06

(52) U.S. Cl. CPC A47J 37/0611; A47J 2037/0617

(57) ABSTRACT

An indoor grill comprises a plate and an additional plate. In various embodiments the plate is coupled to the additional plate via a hinge or other suitable fastener allowing a distance between the plate and the additional plate to be changed. A heating element is coupled to the plate and to the additional plate that is configured to transfer heat to one or more of the plate and the additional plate. In various embodiments, the plate includes one or more patterns of spikes that pierce a surface of food placed on the indoor grill when pressed against the food. Heat from the heating element is transferred to the spikes, so when the spikes pierce the food, heat from the spikes heats the food from below the surface of the food. In some embodiments, the additional plate also includes one or more patterns of spikes.

### CROSS REFERENCE TO RELATED APPLICATIONS

This application claims the benefit of U.S. Provisional Application No. 62/812,310, filed Mar. 1, 2019, which is incorporated by reference in its entirety.

### BACKGROUND

This invention relates generally to indoor grills, and more particularly to an indoor grill that more efficiently cooks food.

Indoor grills are popular household items allowing users to grill food on indoor countertops by heating metallic plates with electric power. Conventional indoor grills have various configurations. For example, certain conventional indoor grills have slightly angled units allowing grease to run off the metallic plates. In other examples, conventional indoor grills have shapes within their metallic plates, such as lines to simulate grill marks or novelty images. However, different configurations of conventional indoor grills result in similar cooking methods and cooking times, as the different configurations heat food from a metallic plate proximate to a top of food in the indoor grill and from another metallic plate proximate to a bottom of the food. top of the food and the bottom of the food. Thus, conventional indoor grill configurations have limited efficiency for cooking times and infusion of flavor to foods when cooking.

### SUMMARY

To increase efficiency and speed of cooking foods on an indoor grill, an indoor grill comprises a plate and an additional plate. In various embodiments the plate is coupled to the additional plate via a hinge or other suitable fastener allowing a distance between the plate and the additional plate to be changed. A heating element is coupled to the plate and to the additional plate that is configured to transfer heat to one or more of the plate and the additional plate. In various embodiments, the plate includes one or more patterns of spikes that pierce a surface of food placed on the indoor grill when pressed against the food. Heat from the heating element is transferred to the spikes, so when the spikes pierce the food, heat from the spikes heats the food from below the surface of the food. In some embodiments, the additional plate also includes one or more patterns of spikes.

### BRIEF DESCRIPTION OF THE DRAWINGS

FIG. 1 is a plan view of an indoor grill comprising a plate having a pattern of spikes, in accordance with an embodiment.

FIG. 2 is a plan view of an indoor grill comprising a plate having a pattern of spikes in an open configuration, in accordance with an embodiment.

FIG. 3 is a plan view of an indoor grill with food positioned between a plate having a pattern of spikes and an additional plate, in accordance with an embodiment.

FIG. 4 is a side view of food onto which the plate having a pattern of spikes has been previously pressed, in accordance with an embodiment.

FIG. 5 is a side view of a plate having a pattern of spikes being pressed into food and heat transfer from the plate to the food, in accordance with an embodiment.

FIG. 6 is a plan view of an indoor grill having a plate with a pattern of spikes rotated about a horizontal axis, in accordance with an embodiment.

FIG. 7 shows plates of an indoor grill having sub-regions onto which food may be placed, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

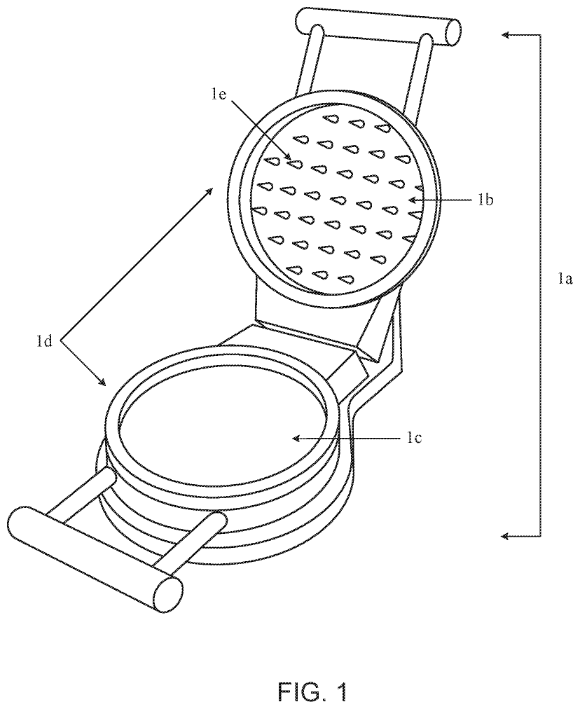

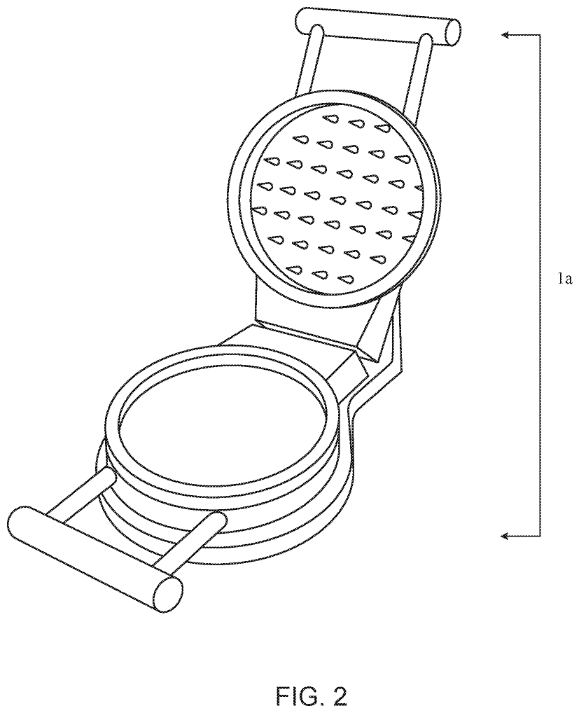

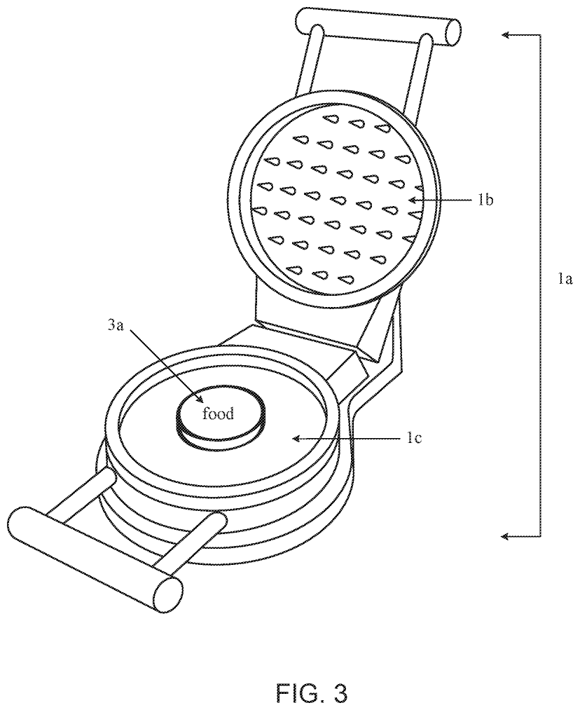

FIG. 1 is a plan view of one embodiment of an indoor grill 1a comprising a plate having a pattern of spikes. The indoor grill 1a comprises a plate 1b and an additional plate 1c. In various embodiments the plate 1a is coupled to the additional plate 1c via a hinge or other suitable fastener allowing a distance between the plate 1b and the additional plate 1c to be changed. A heating element 1d is coupled to the plate 1a and to the additional plate 1b that is configured to transfer heat to one or more of the plate 1b and the additional plate 1c. In various embodiments, the plate 1b includes one or more patterns of spikes 1e that pierce a surface of food placed on the indoor grill 1a when pressed against the food. Heat from the heating element 1d is transferred to the spikes 1e, so when the spikes 1e pierce the food, heat from the spikes 1e heats the food from below the surface of the food. In some embodiments, the additional plate 1c also includes one or more patterns of spikes. FIG. 2 shows the indoor grill 1a in an open configuration with separation between the plate 1b and the additional plate 1c. FIG. 3 shows the indoor grill with food 3a positioned between the plate 1b and the additional plate 1c.

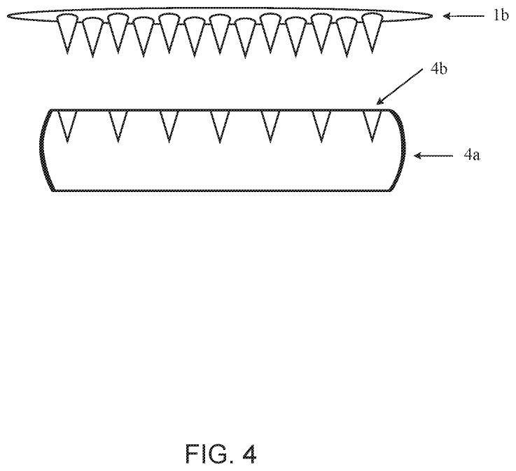

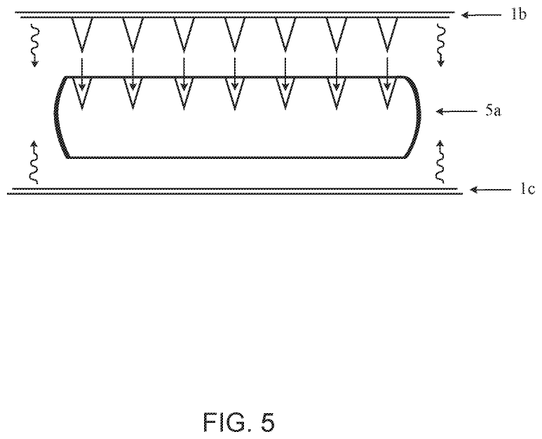

FIG. 4 shows a side view of food 4a onto which a plate 1b having a pattern of spikes 1e has been previously pressed. As shown in FIG. 4, pressing the plate 1b with the pattern of spikes 1e into food 4a creates a pattern 4b of piercing upon the food. FIG. 5 shows a side view of a plate 1b having a pattern of spikes 1e being pressed into food 5a and heat transfer to the food 5a. As shown in FIG. 5, food 5a is positioned between the plate 1b having the pattern of spikes 1e and the additional plate 1c. The plate 1b and the additional plate 1c contact the food 5a, with the pattern of spikes 1e piercing a surface of the food 1e. Heat from the plate 1b and the additional plate 1c is transferred to the food 5a via surfaces of the food 5a contacting the plate 1b and the additional plate 1c. Similarly, heat from the spikes 1e is transferred to the food 5a where the spikes 1e pierced the surface of the food 5a, allowing heat to be transferred to the food 5a below the surface of the food 5a contacting the plate 1b.

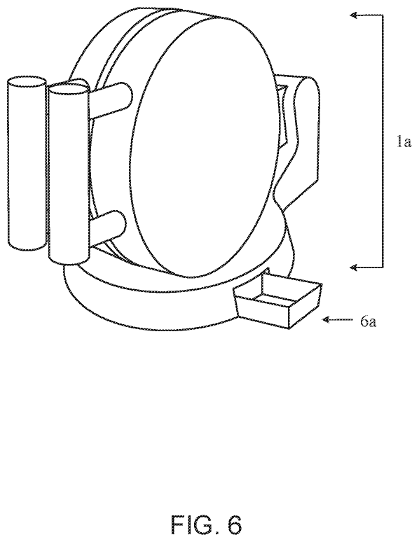

FIG. 6 is a plan view of an indoor grill 1a including a plate 1b with a pattern of spikes 1e rotated about a horizontal axis. Rotating the indoor grill 1a around its horizontal axis allows fats or grease to drain from the plate 1b and from the additional plate 1c. In various embodiments, the indoor grill 1a includes a catch basin 6a below the plate 1b and the additional plate 1c and positioned so fats or grease drain from the plate 1a and from the additional plate 1c into the catch basin 6a when the plate 1a and the additional plate 1c are rotated to be perpendicular to the horizontal axis of the indoor grill 1a. In various embodiments, the catch basin 6a is positioned to be below a location where a surface of the plate 1b is nearest a surface of the additional plate 1c when the plate 1b and the additional plate 1c are perpendicular to the horizontal axis.

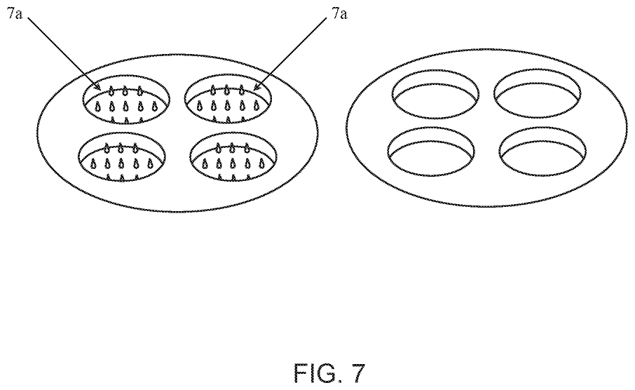

FIG. 7 shows plates of an indoor grill having sub-regions 7a onto which food may be placed, in accordance with an embodiment. In the example of FIG. 7, each plate of the indoor grill includes a plurality of sub-regions 7a, with each sub-region 7a configured to receive a portion of food. A sub-region 7a of one of the plates includes a pattern of spikes configured to pierce food positioned on the sub-region 7a, as further described above in conjunction with FIG. 1. In some embodiments sub-regions 7a on one of the plates include the pattern of spikes, while sub-regions 7a on the other plate does not include the pattern of spikes; in other embodiments, sub-regions 7a included on both plates include the pattern of spikes. The pattern of spikes is limited to being within the sub-regions 7a, so portions of the plates outside of the sub-regions 7a do not include the pattern of spikes. The sub-regions 7a may have any suitable shape (e.g., circular, elliptical, rectangular, square, etc.) in various embodiments, and the plates may include different numbers of sub-regions 7a in different embodiments.

### SUMMARY

The foregoing description of the embodiments of the invention has been presented for illustration; it is not intended to be exhaustive or to limit the invention to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. An apparatus comprising:
a plate having one or more patterns of spikes, each spike configured to pierce a surface of food contacting the plate;
an additional plate coupled to the plate, a distance between the plate and the additional plate capable of being changed; and
a heating element coupled to the plat and configured to transfer heat to the plate, which transfers heat to the one or more patterns of spikes.

2. The apparatus of claim 1, wherein the additional plate includes one or more patterns of spikes each configured to pierce another surface of food contacting the additional plate.

3. The apparatus of claim 1, wherein the additional plate is coupled to the plate via a hinge.

4. The apparatus of claim 1, wherein the heating element is coupled to the additional plate and is configured to transfer heat to the additional plate.

5. The apparatus of claim 1, wherein the plate and the additional plate are configured to rotate about a horizontal axis.

6. The apparatus of claim 5, wherein the plate and the additional plate are configured to rotate to be perpendicular to the horizontal axis.

7. The apparatus of claim 6, further comprising a catch basin positioned below a location where a surface of the plate is nearest a surface of the additional plate 1c when the plate and the additional plate are perpendicular to the horizontal axis.

8. The apparatus of claim 1, wherein the plate comprises one or more sub-regions, each sub region including the one or more patterns of spikes.

9. The apparatus of claim 8, wherein portions of the plate other than the one or more sub-regions do not include the one or more patterns of spikes.
